(19) United States
(12) Patent Application Publication
(10) Pub. No.: US 2014/0050050 A1
(43) Pub. Date: Feb. 20, 2014

(54) MICROSEISMIC SOURCE LOCATION ESTIMATION WITH HIGH RESOLUTION USING GREEN'S FUNCTIONS

(71) Applicants: Tong W. Fei, Dhahran (SA); Yi Luo, Dhahran (SA); Mohammed N. Alfaraj, Dhahran (SA); Gerard T. Schuster, Salt Lake City (US)

(72) Inventors: Tong W. Fei, Dhahran (SA); Yi Luo, Dhahran (SA); Mohammed N. Alfaraj, Dhahran (SA); Gerard T. Schuster, Salt Lake City (US)

(73) Assignee: SAUDI ARABIAN OIL COMPANY, Dhahran (SA)

(21) Appl. No.: 13/884,148

(22) PCT Filed: Nov. 4, 2011
(86) PCT No.: PCT/US11/59347

§ 371 Date: Oct. 31, 2013

(30) Foreign Application Priority Data
Nov. 8, 2010 (US) 12941644

(51) Int. Cl. G01V 1/28

(52) U.S. Cl. CPC G01V 1/288
USPC 367/38

(57) ABSTRACT

The sources of microseismic hydraulic fracture events (“hydro-fracs”) are located for image mapping by the calculation of Green's functions G(x, z, t|x′, z′, 0) which is estimated using, e.g., RVSP, VSP, SWD and/or surface data, with the Green's functions used as migration kernels with greater accuracy than the prior art techniques, e.g. the diffraction limit, because all of the natural arrivals in the data are utilized.

### FIELD OF THE INVENTION

The invention relates to the monitoring and estimation, with a high degree of resolution, of the location of subsurface microseismic sources associated with fluid movement in hydrocarbon-containing reservoir rock.

### BACKGROUND OF THE INVENTION

The accurate monitoring of fluid movement in hydrocarbon reservoirs is essential for increasing the recovery from the reservoir rock reserves. Direct measurement of fluid flow in the reservoirs, if at all possible, is a complex and expensive task. As a result, indirect methods have been investigated. One useful approach is to measure source locations of seismic events, which are often triggered by rock fractures resulting from fluid movement. These microseismic hydraulic fracture events are also referred to as “hydro-fracs”. An important step in locating the seismic sources are the calculation of Green's functions, which can be used to map the recorded seismic energy to where it was generated to thereby identifying the source locations.

Reservoir management based on microseismic signals emanating from reservoir rock requires the precise estimation of the microseismic event source locations to optimally guide fluid-injection rates and injection locations. A problem encountered in the field is that the required precision of the microseismic source location is beyond the seismic resolution of a typical passive seismic array located on the surface. The narrow aperture of the surface receivers, high signal/noise ratios, and the relatively long wavelengths of the source prevent a precise seismic estimate of where the rock is being fractured.

A sophisticated mathematical analysis, or analytical tool, referred to as a propagator function, can be applied to an area of interest in order to map the recorded seismic energy to its source location. It has been known in the art to utilize Green's functions in connection with the analysis of available data.

The following patent documents disclose various methods relating to the use of Green's functions in modeling seismic data.

Brandsberg-Dahl et al. USP 2008/0130411 disclose a method utilizing a measured (near-exact) Green's functions that requires vertical seismic profile (“VSP”) data to image the surface seismic data. The methods of Brandsberg-Dahl et al. are described as being applicable to instances where the velocity profile is approximately one-dimensional and where there are lateral velocity variations. Imaging of surface seismic data and “self-imaging” of VSP data is disclosed as being possible without first having to estimate a velocity model. The measurements obtained from the VSP data can also be used as a tool for calibrating computed Green's functions and migration operators, e.g., in a Kirchoff migration or other type of migration.

Etgen U.S. Pat. No. 6,049,759 discloses a process that is based upon the observation that an underlying 3-D velocity model consisting of horizontally layered constant-velocity media (i.e., a so-called v(z) velocity model) results in prestack migration of a collection of common offset traces that can be written as a convolution of a migration operator with the seismic data. Based on this observation, Etgen discloses that the speed of the migration may be increased by transforming both the migration operator and the seismic data to another domain, such as a Fourier transform, where the convolution between the two can be calculated more efficiently. The process starts with specification of a velocity model that does not vary with respect to the x or y (horizontal) coordinates. It is critical to this instant embodiment that this model be horizontally layered if the migration result is to be exact. In a preferred embodiment disclosed by Etgen, two Green's function arrays are computed from the information contained within the velocity model. The two arrays theoretical travel times and resulting amplitudes of a wave front that originates as a point source on the surface is measured remotely at various radial distances and depths within the specified velocity model. The Green's function arrays are used in the calculation of the migration operator. Etgen discloses that the Green's functions need be calculated only once for the entire migration, as the velocity model is constrained to be horizontally layered. The choice of a particular migration approach (e.g., Kirchhoff migration, finite difference migration, an F-K algorithm, a finite element algorithm, or a reflectivity algorithm) determines the equations that are used to calculate the values within the operator volume. The migration operator is then applied to a common offset seismic data volume, and a discrete 3-D Fourier transform of the common offset data volume is calculated. The migration then continues by operating on a set of individual constant frequency slices taken from the volume of 3-D Fourier transform coefficients. Etgen process must be based on the velocity model. In addition, the use of Green's function in Etgen is a precursor to another migration operator, such as Kirchhoff migration.

Marmalyevskyy, et al. U.S. Pat. No. 7,110,323 discloses a method for using non-primary reflections to identify and characterize steeply dipping sub-vertical events. Secondary reflections or duplex waves are migrated while the effects of primary reflections are suppressed. Substantially vertical events are located by gathering common source or receiver traces for processing. Wave fields of these gathers are continued downward to the level of the base boundary, and then a seismic image of sub-vertical events is formed at each discrete depth level. The migration of non-primary reflections is generally based on the Kirchoff transformation whereby the Green's function is repeatedly recalculated along the subject fault according to the kinematics of the subject non-primary reflections, while the velocity model is that used for conventional migration procedures.

He, et al. U.S. Pat. No. 5,798,982 discloses a method for constructing an impedance model of a subsurface volume including obtaining a 3-D seismic image of the subsurface volume from observed seismic reflection trace data, constructing an a priori impedance model of the subsurface volume based on estimated impedance trends within the subsurface volume, and creating a model of the seismic reflection trace data for the subsurface volume based on the a priori impedance model by combining the a priori impedance model with a seismic source function or wavelet which is time/depth dependent. The model and the observed seismic reflection trace data are compared and the a priori impedance model is modified to decrease the variation. This process is directed to obtaining different information and, as in the prior reference, there is no application of Green's function in He, et al. as a propagator function.

The following additional patent references describe the use of various types of functions that are used to provide models to provide migrated seismic data, without specific reference to Green's function: Martinez et al. U.S. Pat. No. 6,826,484; Thomsen U.S. Pat. No. 6,128,580; Reshef et al. U.S. Pat. No. 6,904,368; Kelly U.S. Pat. No. 6,687,617; Carrazzone, et al. U.S. Pat. No. 5,583,825; Lee et al. U.S. Pat. No. 7,388,808; Meng U.S. Pat. No. 6,519,532; Ober et al. U.S. Pat. No. 6,021,094; Tal-Ezer U.S. Pat. No. 6,819,628; Ren U.S. Pat. No. 7,035,737; Kelly U.S. Pat. No. 7,039,526; and Ren et al. U.S. Pat. No. 6,466,873.

From the above, it will be understood that it is well known that a seismic image can be obtained by correlating Green's functions, as well as various other functions, with seismic data. In accordance with the prior art, the Green's function could be obtained by two methods:

a. by forward modeling with known a velocity model, such as ray-tracing, finite-difference extrapolation, phase-shift, and others; or

b. by direct measurement based on classical VSP data, such as was described above in the Brandsberg-Dahl, et al. US2008/0130411 disclosure.

The known methods of the prior art in some instances produce results lacking in the desired level of accuracy in mapping the microseismic event source locations due to the assumptions made in processing the data utilized and/or the methods require complex, and therefore expensive, arrays of equipment to collect the data required to practice the method. One particular limitation is the requirement of developing a velocity model.

It is therefore an object of the present invention to provide an improved method for deriving and use of Green's functions as the propagator function in order to more accurately image or map the location of microseismic events that originate in a volume of reservoir rock.

It is another object of this invention to overcome prior art resolution limitations that are the result of sparse passive recording geometry.

A further object of this invention is to provide a method of utilizing all the natural arrivals in the data for a given reservoir region in order to estimate the locations of microseismic sources with super resolution.

### SUMMARY OF THE INVENTION

In accordance with the present invention, the Green's function is derived from the seismic data itself, that is, no velocity model is necessary. The process of the invention provides a seismic image for identifying the location of a subsurface microseismic hydro-frac event initiated by fluid movement in a predetermined region of the reservoir rock with high resolution and includes the steps of:

a. collecting seismic data generated by a drill bit during drilling of a well bore in the reservoir and correlating the seismic data with the corresponding drill bar vibration data;

b. obtaining an estimate of local velocity in the reservoir surrounding the well bore;

c. calculating the natural Green's function(s) for the earth from the seismic-while-drilling data of step (a) using the formula:

G (x+dx|x′)

where x′ is the seismic-while-drilling source location;

d. extrapolating the phase shift migration from data taken along the surface using a migration operator e^{-iωτ}, where ω is frequency and τ is time, as an extrapolation operator to extrapolate the traces to greater depths;

e. collecting seismic data corresponding to one or more microseismic events occurring in the predetermined region of the reservoir;

f. applying the Green's function(s) obtained in step (c) to estimate the location of the microseismic events associated with the data of step (e) in accordance with the following formula:

m(x+dx)=G(x+dx|x′)*d(x′)dx′ [1]

where d(x′) represents passive seismic data in the frequency domain along the surface x′, and m(x′) represents the image of the point scatterer, which is equivalent to zero-offset migration of post stack data, and x+dx represents the unknown location of the hydro-frac source and the integration is over the trace locations on the surface; and

g. displaying the results of solving the formula of step (f) as images corresponding to the location of the one or more microseismic events.

The “natural” Green's function is constructed, e.g., by correlating the drill bar vibration corresponding to the pilot signal for the drill bit with the seismic waves generated by the drill bit while drilling in the region of interest. The Green's function(s) are also derived by summing correlated traces between master traces and the remaining traces in shot gathers. In this method, all of the natural arrivals in the data are used. When additional measurements become available, the data can be used to further refine and/or confirm the reliability of the Green's functions that have been applied. The additional measurement can also be used as a cross-check for the method of the invention. The additional measurements can also be used in combination with the method of the invention to improve the accuracy of the images generated.

In accordance with this invention, the band-limited Green's function G(x,z,t|x′,z′,0) can also be estimated from VSP (vertical seismic profile), RVSP (reverse VSP), or surface seismic data and applied to estimate the location of hydro-frac source locations. These Green's functions are used as the migration kernels and provide estimates of the hydraulic fracturing source locations that are more accurate than the diffraction limit method because all of the natural arrivals in the data are utilized.

The Green's function G(x,z,t|x′,z′,0) can be estimated from surface seismic data using several alternative methods. The Green's function can be obtained by recording the drill bit pulses on the surface, which is equivalent to RVSP data. The pilot signal for the drill bit is recorded at the drill bit and then correlated with the observed data to get the impulse-like Green's function. The Green's function can also be approximated by a VSP-type experiment. To estimate the Green's functions at locations near the drill bit, wavefield extrapolation methods can be used that are similar to the wave field extrapolation of seismic data when a local velocity model is of the present invention is obtained by conventional well logging methods. However, in the method of the present invention no local velocity model is required.

Another method for estimating the Green's function is by correlating every trace in a surface seismic shot gather with a master trace in the same shot gather and then summing the resulting correlation trace for all shot gathers to yield G(x,z,t|x′,z′,0). This Green's function G(x,z,t|x′,z′,0) is for a scatterer buried at (x′,z′) as if it were a buried source shooting into surface geophones at (x,z) and listening time t. The estimated Green's function resembles that of a shot gather for an RVSP experiment, except that it is freely available from surface seismic data rather than from an expensive RVSP experiment. This procedure can be used to complement common focus point (CFP) methods that are based on certain assumptions about seismic statics. Such assumptions are not required in the practice of the method of the present invention.

As used herein the term “shot gather” includes the energy or waves emanating from microseismic hydraulic fracture events in the reservoir rock.

### BRIEF DESCRIPTION OF THE DRAWINGS

The invention will be described in further detail below and with reference to the attached drawings and illustrations in which:

FIG. 1 is a schematic illustration of seismic-while-drilling data collection in a horizontal portion of a well;

FIG. 2 is a schematic illustration comparing the results of a prior art Kirchhoff migration with the full trace, or reverse time migration of the present invention;

FIG. 3 is a schematic illustration of data collection for a salt body model and an RVSP well with a point scatter image;

FIGS. 4A and 4B are computer-generated images of wave fronts resulting from application of a migration operator in the space-time domain for an early-arrival migration and a full-trace migration, respectively;

FIG. 5 includes migration images of 60 ms early-arrival migration and full-trace migration without noise;

FIG. 6 includes migration images similar to those of FIG. 5 in which a predetermined average noise level has been included in the data;

FIG. 7 is a schematic representation of walkaway VSP geometry for the reservoir site VSP data;

FIG. 8 includes migration traces similar to those of FIG. 6 in which the data are taken from the field VSP traces associated with the geometry depicted in FIG. 7;

FIG. 9 is a process flow diagram of steps carried out using the system and method of the present invention; and

FIG. 10 is a block diagram of a system for implementing the invention.

### DETAILED DESCRIPTION OF THE INVENTION

In accordance with this invention, Green's function G(x,z,t|x′,z′,0) is estimated from various data sources, including RVSP, VSP, SWD or surface data, and used to provide images of the estimated locations of hydro-frac sources with a high degree of resolution. These Green's functions can be used as the migration kernels to estimate hydro-frac source locations with greater accuracy than the diffraction limit, because all of the natural arrivals in the data are utilized.

Green's function can be estimated from surface seismic data using two different methods. The first method is to use the drill bit as a seismic source as is known in the seismic-while-drilling (SWD) methods. The seismic data are recorded on the surface and correlated with the recorded pilot signal to give the impulse-like Green's function. Evaluation of the Green's function far from the drill bit is achieved by employing a wavefield continuation method using a local velocity model.

The second method estimates the Green's function by correlating a trace in the surface seismic shot gather with a master trace in the same shot gather and then summing up the resulting correlation trace for all shot gather yields G(x,z,t|x′,z′,0). This Green's function G(x,z,t|x′,z′,0) is for a scatterer buried at (x′,z′) as if it were a buried source shooting into surface geophones at (x,z). The estimated Green's function resembles that of a shot gather for an RVSP experiment, except that it is freely available from surface seismic data rather than from an expensive RVSP experiment. This method can be used as a complement to common focusing point (CFP) methods that have certain assumptions about seismic statics. Such assumptions are not required by interferometric redatuming.

Once the Green's function is estimated from the data, the source is located by seeking the maximum value of the migration image m(x′,z′,t) for all trial source locations (x′,z′) in the model and time shift values t; the summation is over all trace indices g and over the temporal variable t′. Here d(g,0,t) represents the passive data recorded on the surface at location (g,0) where the Cartesian coordinate system's origin is at the surface and z=0 defines the free surface. Also, G(g,0,t|x′,z′,0) represents the recorded Green's function for a source at (x′,z′) and receiver at (g,0). For brevity, the notation here is illustrated for a 2D model, but this method is equally applicable to a 3D model with an areal recording array on the surface. For a 3D application, the G(g,0,t|x′,z′,0) representation is replaced with the 3D representation G(x,y,z,t|x′,y′,z′,0) and d(x,z=0,t) by d(x,y,z=0) where the y axis is in and out of the page and perpendicular to the x-z plane.

In accordance with the present invention, the Green's function G(x,z,t|x′,z′,0) of a subterranean region is estimated from (1) vertical seismic profile (VSP) data, (2) reverse vertical seismic profile (RVSP) data, (3) seismic-while-drilling (SWD) data, or (4) seismic surface data. The estimated Green's function is then used in a migration image function, and the maximum value of the migration image provides the estimated location(s) of the hydro-fracturing source(s). The migration image m(x′,z′,t) can be represented as: m(x′,z′,t)=sum_g sum_t′ G(g,0,t+t′|x′,z′0), d(g,0,t′). This value is determined for all trial source locations (x′,z′) in the model and time shift values t. The summation is over all trace indices g and over the temporal variable t′. In the equation, d(g,0,t) represents the passive data recorded on the surface at location (g,0) where the Cartesian coordinate system's origin is at the surface and z=0 defines the free surface. Also, G(g,0,t|x′,z′,0) represents the recorded Green's function for a source at (x′,z′) and a receiver at (g,0).

In prior art migration techniques, such as standard Kirchhoff migrations, the model is based upon a narrow receiver aperture and coarse geophone sampling which results in imperfect cancellation of neighboring ellipses in the migration image. Consequently, artifacts appear as “wide smiles.” However, in accordance with the present invention, a reverse time migration is used with Green's function as the operator, i.e., full-trace migration, where data is summed along traveltime curves associated with all events. This provides super resolution capabilities, which is also known as multi-arrival super resolution, because it effectively extends the aperture of the recording experiment.

In accordance with the invention, and in order to address these limitations of the prior art, the Green's function G(x|x′) of the earth is obtained from the drill bit as will be described in more detail below, or VSP experiment, and this Green's function is used to image the hydro-frac source location to better than the diffraction limits of the seismic recording, i.e., less than 5* L horizontal resolution where L is aperture width and z is depth. Most importantly, for the practice of the method of the present invention, no global velocity model is needed.

The Green's function obtained from a seismic-while-drilling (SWD) experiment is used to estimate the location of the hydro-frac sources using the following formula.

m(x+dx)=G(x+dx|x′)*d(x′)dx′ [1]

where d(x′) represents passive seismic data in the frequency domain along the surface x′, and m(x′) represents the image of the point scatterer, which is equivalent to zero-offset migration of post stack data, and x+dx represents the unknown location of the hydro-frac source and the integration is over the trace locations on the surface.

The Green's function G(x+dx|x′) in equation 1 can be estimated from the measured SWD Green's function G(x|x′), where x′ is the SWD source location by a typical extrapolation operation. For example, phase shift migration takes data along the surface and extrapolates the traces to deeper depths by an exponential-like extrapolation operator. A similar procedure can be applied to a series of SWD Green's functions obtained from a series of sources along the well trajectory, except that the sources are extrapolated away from the well bore. This extrapolation requires a local estimate of the velocity around the well, which are easily obtained from the well logs or other similar procedures known to the art.

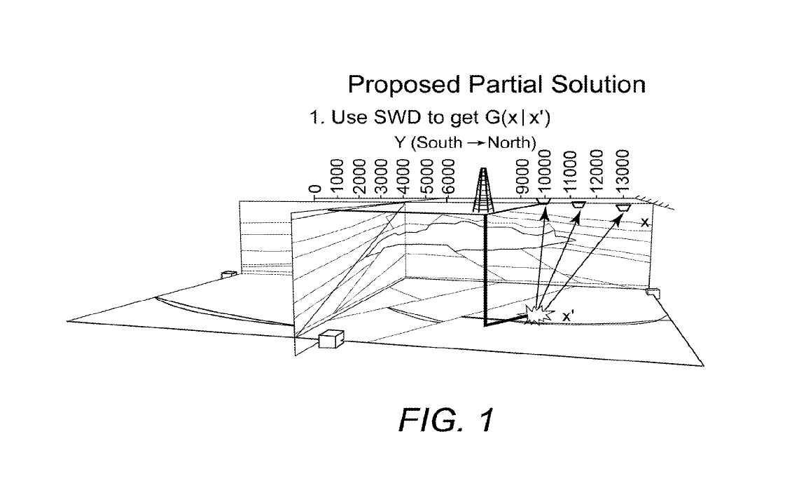

Referring to FIG. 1, the drill bit advancing in a horizontal well at x′ creates seismic waves that are naturally recorded on the surface at x. This gives the Green's function G(x|x′), which is a solution to the Helmholtz equation, and that can be used to provide an image of the weaker hydro-frac sources. No velocity model is needed in the method of the invention.

Utilization of equation 1 overcomes the resolution limitations inherent in a sparse passive recording geometry. This is because equation 1 uses the natural Green's function of the earth, which includes all events, such as multiples and diffractions. Using this method provides super resolution, which is also referred to as multi-arrival super resolution capabilities because it effectively extends the aperture of the recording process or protocol.

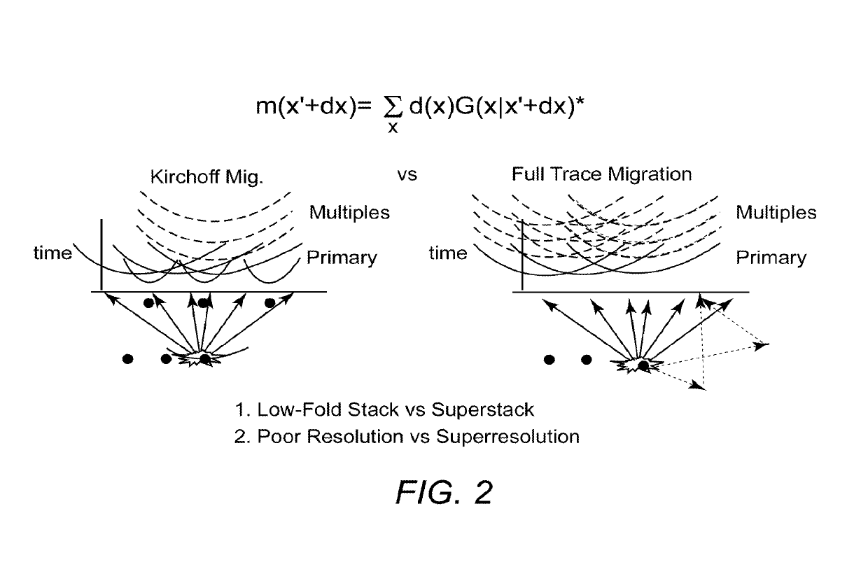

FIG. 2 illustrates the advantage of the method of the invention by comparing a standard Kirchhoff migration (left side) to the full-trace migration (right side). For the Kirchhoff migration (i.e., using the single-arrival Green's function G(x|x′)=e^{i·t}^{_{xx′}} in equation 1, where t_{xx′} is the traveltime for a wave to propagate from x to x′), the trial image point at a buried location represented by the dot on the left-hand side of FIG. 2 requires the summation of data along the appropriate hyperbola (red curves) in x-t space. For a narrow receiver aperture and coarse geophone surface sampling setup, this leads to imperfect cancellation of neighboring ellipses in the migration image. Consequently, artifacts appear as wide smiles in x-z space, such as that on the left-hand side of FIG. 2. This result is of less resolution than the result obtained using the natural Green's function of equation 1 that includes all arrivals.

With further reference to the illustrations of FIG. 2, it will be understood from the representation on the left that the Kirhhoff migration sums data along a single hyperbola, while the reverse time migration, i.e., full-trace migration depicted to the right sums data along traveltime curves associated with all events. This full-trace migration has better fold and better resolution than the single-arrival Kirchhoff migration images.

With continuing reference to the illustration on the right-hand side of FIG. 2, it can be seen that any trial image point (e.g., the dot) is formed by summing data along all of the single-arrival (solid hyperbola) and multi-arrival (dashed hyperbola) diffraction curves. Two typical raypaths for the multi-arrival curves are represented by the two dashed white rays in x-z space on the right-hand side of FIG. 2. These extra raypaths provide a wider range for ray angles of rays incident on the image point which leads to a better resolution of the migration image. This results in the migration smile being narrower than the one in the Kirchhoff image. Moreover, the increased stacking power of the many additional diffraction curves increases the signal/noise ratio by the square root of NM, where N is the number of traces and M is the total number of the single-arrival curves and the multi-arrival diffraction curves summed over for any one trial image point. This compares favorably to the standard Kirchhoff migration, which increases the signal/noise ratio by the square root of N.

A further advantage of the method of the invention that improves image resolution is the inclusion of evanescent waves in imaging the data. An evanescent wave is a nearfield standing wave with an intensity that exhibits exponential decay with distance from the boundary at which the wave was formed. Evanescent waves are a general property of wave-equations, and can, in principle, occur in any context to which a Green's function wave-equation applies. Evanescent waves are formed at the boundary between two media having different wave motion properties and are most intense within one-third of a wavelength from the surface of formation. Evanscent waves are formed when seismic waves traveling in a region of an underground geological formation undergo total internal reflection at the formation boundary because they strike it at an angle greater than the critical angle. The physical explanation for the existence of the evanescent wave is that the pressure gradients of acoustical waves cannot be discontinuous at a boundary, as would be the case if there were no evanescent wave-field.

### Numerical Results

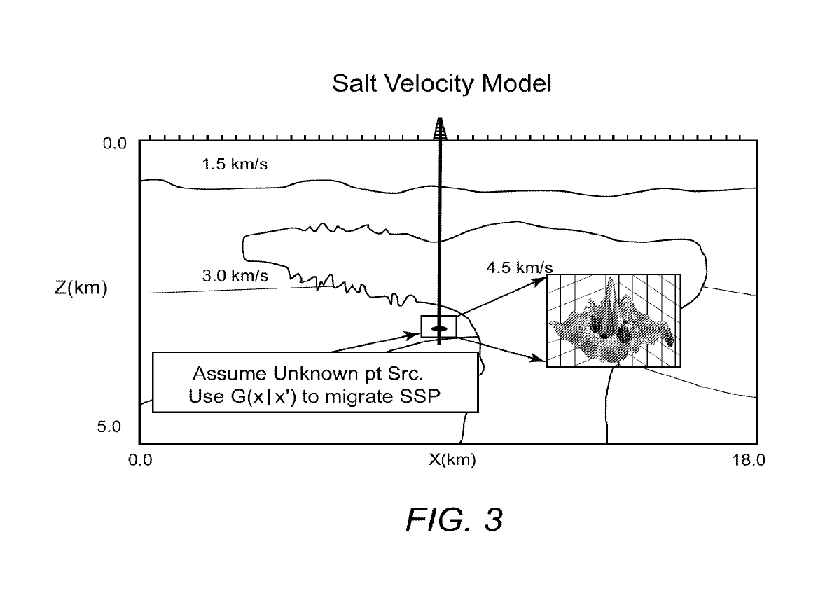

Both synthetic and field RVSP data have been used to confirm the accuracy of the method of the present invention. The synthetic data were generated for the Red Sea salt body model shown in FIG. 3 and the field data are from a 2D walkaway VSP data survey carried out at a reservoir site. By reciprocity, the VSP data was transformed into RVSP data by interchanging the locations of the buried geophones with the surface sources.

The synthetic RVSP salt body data were generated by a 2D finite-difference solution to the acoustic wave equation for 1000 surface geophone receivers spaced at 20 m intervals. The RVSP point sources for a vertical well were buried at depths starting at 3100 m, and spaced at 20 m intervals to deeper depths; in total, 50 shot gathers were generated for this RVSP configuration as shown by the vertical white bar in FIG. 3. These sources are treated as point sources even though the 2D modeling assumes elongated line sources in and out of the page; the peak frequency of the source wavelet was 35 Hz.

Equation 1 is used to image the location of an unknown point source located somewhere along the well. In the examples, the point source location is at the depth of 3500 m along the well. The full-trace migration images are compared to the early-arrival migration images, and a time window is used to mute out all arrivals except the earliest arrivals. For example, a 60 ms early-arrival migration operator includes only the arrivals within a 60-ms duration time window centered about the first onset of energy in the trace. The 3D image of the point scatterer is shown in the inset in FIG. 3.

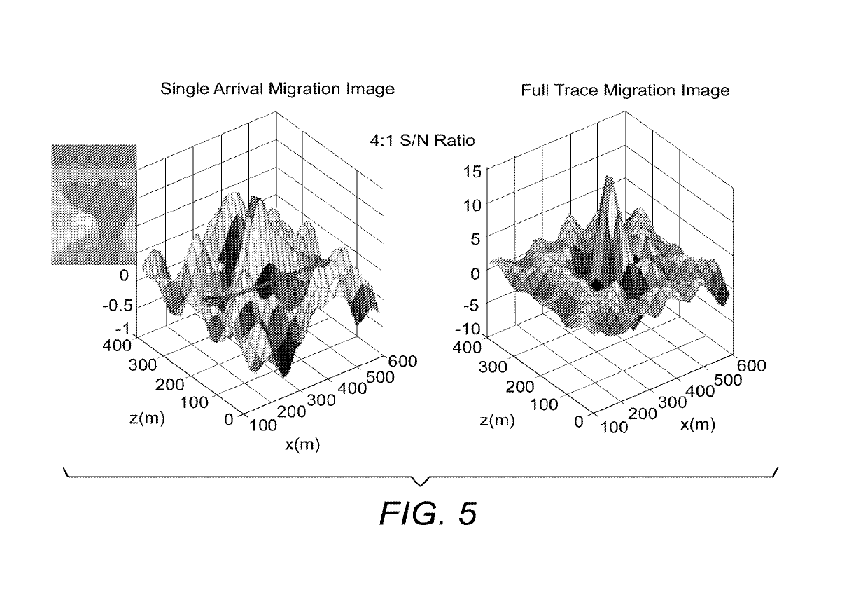

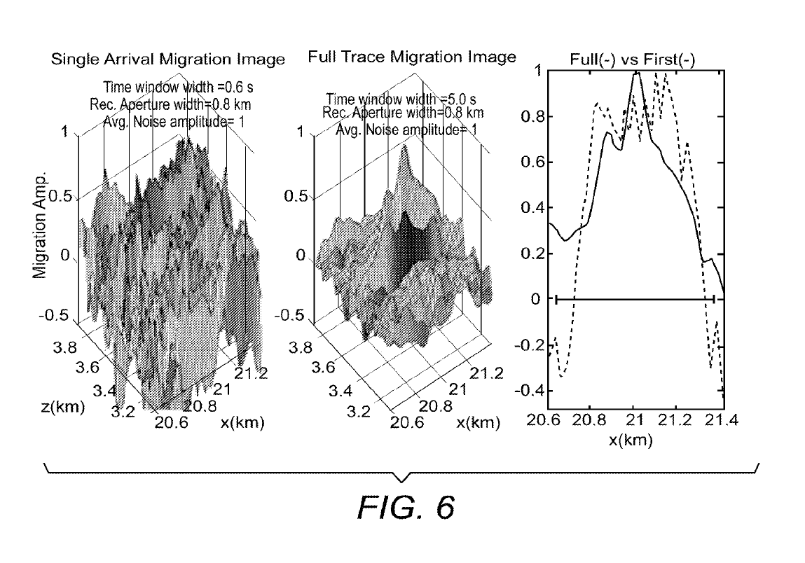

The early-arrival migration operator will have less resolution than the full-trace operator, because it only accounts for the direct wave field and does not include all of the scattering events. This predicted result is validated by the point source images shown in FIGS. 5-6. The point source is actually located at the 3500 m depth and is more highly resolved as indicated by the narrower horizontal width of the main lobe of the image in the MI-trace images (middle column of images) compared to the early-arrival images (left column of images). The narrow receiver aperture is 0.8 km and the super resolution property of full-trace migration appears to give more than a 10 percent increase in horizontal spatial resolution.

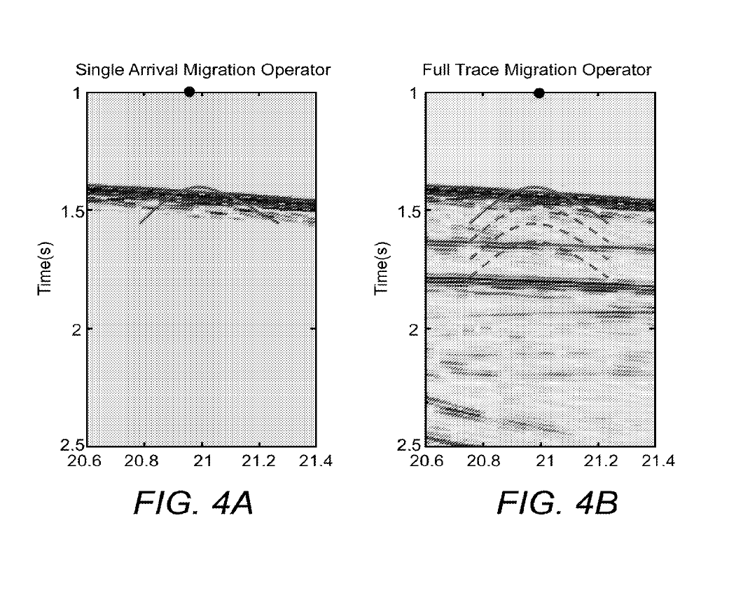

Referring to FIGS. 4A and 4B, the migration operators F′[G(x|x′)] in the space-time domain for a 60 ms early-arrival migration is shown in 4A and for a full-trace migration in FIG. 4B. The F′ symbol denotes the inverse Fourier transform in the frequency domain. The single-arrival operator is obtained from the full trace shot gather of FIG. 4A by muting all events except those within 60 ms of the initial onset of the direct arrival. As will be understood by those of ordinary skill in the art, the designation “early-arrival migration operator” is also appropriately used.

Typically, the signal/noise ratio of an image is enhanced by {N}^{1/2}, where N is the number of traces with additive random noise. With super stacking, it is theoretically possible to increase the signal/noise ratio by a factor of {N+M}^{1/2}, or more, where M is the number of strong reflection events in the migration operator shown in FIG. 4.

Referring now to FIG. 5, migration images are illustrated at a depth of 3.5 km formed by using (left column) 60 ms early-arrival migration and (right column) full-trace migration of noiseless RVSP data for a narrow receiver aperture width on the surface. The horizontal double-sided arrow is the theoretical far-field resolution limit using the conditions of a peak frequency of 35-Hz, a velocity of 3.3 km/s, and a depth of 3.12 km. The salt model appears in the inset on upper left.

With reference to FIG. 6, it will be noted that the images are similar to FIG. 5, except that the shot gathers have an average noise level equal to the largest signal amplitude in the shot gather, e.g., with respect to the data used in FIG. 4. The horizontal bar denotes the theoretical resolution limit.

The super fold property is also confirmed by the results shown in FIG. 6, where the migration images were obtained in the same manner as those of FIG. 5, except that the input data consisted of noisy traces with an average amplitude equal to the largest amplitude of the signal.

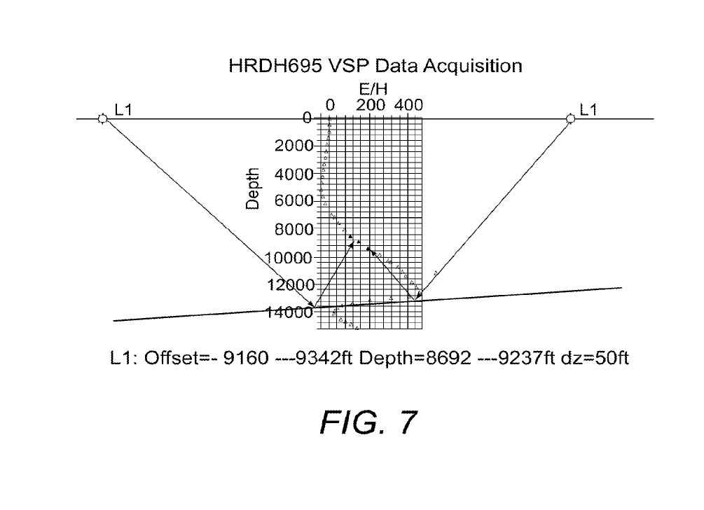

Referring now to FIG. 7, walkaway VSP data was collected from a reservoir site with 223 surface shots at a 26 m shot spacing. Twelve vertical-component geophones were buried at 16-inch depth intervals in a near-vertical well having about a 40 meter horizontal deviation over the geophone depth interval of 312 m. The shallowest receiver depth was 2897 m. FIG. 7 shows an example of a VSP receiver gather along with one of its traces and the magnitude spectrum.

Using reciprocity, the VSP data was transformed into virtual RVSP data. The reservoir site shot gather is referred to below as RVSP data. On this basis, the super resolution properties of the site VSP data can be compared and analyzed with the RVSP synthetic data that was described above.

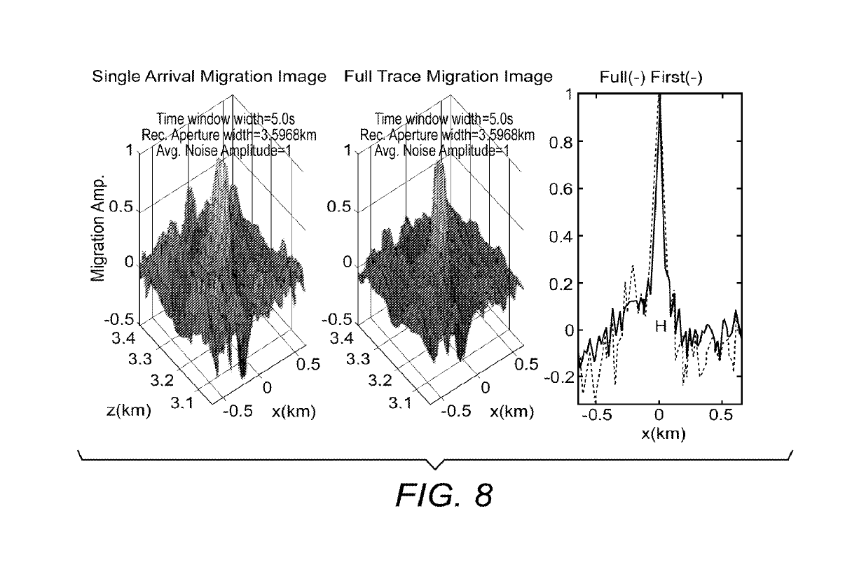

Referring now to FIG. 8, the point-source images from the VSP data are shown for a source aperture width of 35 km on the surface. The receiver source is virtually located at the depth of approximately 2897 m and is more highly resolved, as indicated by the narrower horizontal width of the main lobe of images in the full-trace images in the middle column of images, as compared to the early arrival images shown in the left column of images. The super resolution property of full-trace migration appears to give, at most, a 10 percent increase in horizontal spatial resolution, especially at the receiver aperture of 0.8 km (not shown). Note, the theoretical far-field resolution limit is denoted by the horizontal bar in the cross-sectional plot, and indicates that the theoretical resolution limit is exceeded when the recording aperture on the surface is less than 2 km wide.

It will be noted that the images shown in FIG. 8 are similar to those of FIG. 6, except that the data are taken from the field VSP traces associated with the geometry depicted in FIG. 7. Artificial random noise having an amplitude level equal to that of the largest amplitude in the data has also been added to these data. The horizontal bar in the right-hand graphical display in each of FIGS. 6 and 8 denotes the theoretical resolution limit. The significant difference in the size, or length of the horizontal bars in FIGS. 6 and 8 is due to the frequency content difference in the original data. The image depicted in FIG. 6 is synthetic RVSP data with noise added, while FIG. 8 depicts the field VSP data which had higher frequency content, and the latter therefore has greater resolution.

Synthetic simulations demonstrate the increase in spatial resolution and noise reduction in imaging point source locations with semi-natural Green's functions. These Green's functions are obtained by combining RVSP, VSP, or recorded data with numerical data modeled in a local region about the source point. Using the entire trace as the migration operator produces results that are similar to full-trace migration, except that the velocity model is not needed. Similar to increasing the receiver aperture in the data, spatial resolution and fold are increased by widening the time window in the semi-natural Green's function. A spatial resolution to ¼ of the seismic wavelength appears to be attainable using the apparatus and setup described above. Resolution of up to 1/30^{th} of a wavelength is attainable with use of small-scale scatterers near the well, and the reception of evanescent energy.

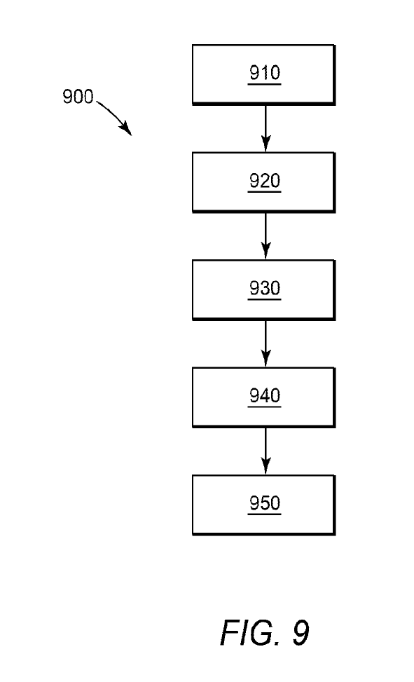

FIG. 9 shows one embodiment of the present invention of identifying the location of a subsurface microseismic hydro-frac event initiated by fluid movement in a predetermined region of reservoir rock. The figure represents a process flowchart 900 of steps.

In step 910, the Green's function G(x,z,t|x′,z′,0) of seismic data of the subterranean region is estimated. A number of estimation methods are available, including seismic surface data, vertical seismic profile (VSP) data, reverse vertical seismic profile (RVSP) data, and seismic-while-drilling (SWD) data.

In step 920, the phase shift migration is extrapolated from data taken along the surface using a migration operator e^{-iωτ}, where ω is frequency and τ is time.

In step 930, seismic data corresponding to one or more microseismic events occurring in the predetermined region of the reservoir is collected.

In step 940, the Green's function(s) obtained in step 910 are applied to estimate the location of the microseismic events associated with the data of step 930 in accordance with the following formula:

m(x+dx)=G(x+dx|x′)*d(x′)dx′

where d(x′) represents passive seismic data in the frequency domain along the surface x′, and m(x′) represents the image of the point scatterer, which is equivalent to zero-offset migration of post stack data, and x+dx represents the unknown location of the hydro-frac source and the integration is over the trace locations on the surface.

In step 950, the results of solving the formula of step 940 are displayed as images corresponding to the location of the one or more microseismic events.

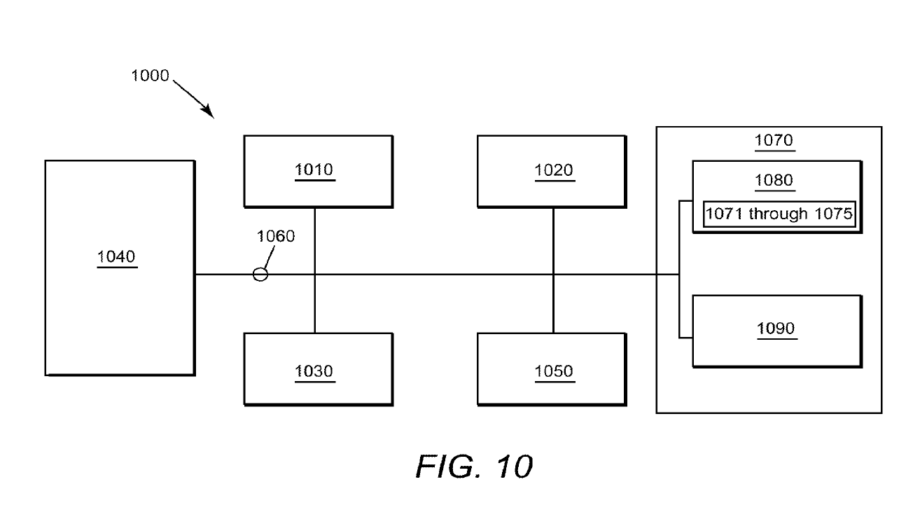

FIG. 10 shows another preferred embodiment of the present invention, implemented in a computer system 1000, with a number of modules. Computer system 1000 includes a processor 1010, such as a central processing unit, an input/output interface 1020 and support circuitry 1030. In certain embodiments, where the computer 1000 requires direct human interaction, a display 1040 and an input device 1050 such as a keyboard, mouse or pointer are also provided. The display 1040, input device 1050, processor 1010, input/output interface 1020 and support circuitry 1030 are shown connected to a bus 1060 which also connects to a memory unit 1070. Memory 1070 includes program storage memory 1080 and data storage memory 1090. Note that while computer 1000 is depicted with the direct human interface components of display 1040 and input device 1050, programming of modules and importation and exportation of data can also be accomplished over the interface 1020, for instance, where the computer 1000 is connected to a network and the programming and display operations occur on another associated computer, or via a detachable input device, as are well known in the art for interfacing programmable logic controllers.

Program storage memory 1080 and data storage memory 1090 can each comprise volatile (RAM) and non-volatile (ROM) memory units and can also comprise hard disk and backup storage capacity, and both program storage memory 1080 and data storage memory 1090 can be embodied in a single memory device or separated in plural memory devices. Program storage memory 1080 stores software program modules and associated data, and in particular stores:

a correlating module 1071 that receives seismic data generated by a drill bit during drilling of a well bore in the reservoir and correlating the seismic data with the corresponding drill bar vibration data;

an estimating module 1072 that estimates local velocity in the reservoir surrounding the well bore;

a first Green's function module 1073 that calculates the natural Green's function(s) for the earth from the seismic-while-drilling data of step (a) using the formula:

G(x+dx|x′)

where x′ is the seismic-while-drilling source location;

an extrapolation module 1074 that extrapolates the phase shift migration from data taken along the surface using a migration operator e^{-iωτ}, where ω is frequency and τ is time, as an extrapolation operator to extrapolate the traces to greater depths; and

a second Green's function module 1075 that receives seismic data corresponding to one or more microseismic events occurring in the predetermined region of the reservoir and applies the Green's function(s) obtained in the first Green's function module to estimate the location of the microseismic events in accordance with the following formula:

m(x+dx)=G(x+dx|x′)*d(x′)dx′

where d(x′) represents passive seismic data in the frequency domain along the surface x′, and m(x′) represents the image of the point scatterer, which is equivalent to zero-offset migration of post stack data, and x+dx represents the unknown location of the hydro-frac source and the integration is over the trace locations on the surface.

It is to be appreciated that the computer system 1000 can be any general or special purpose computer such as a personal computer, minicomputer, workstation, mainframe, a dedicated controller such as a programmable logic controller, or a combination thereof. While the computer system 1000 is shown, for illustration purposes, as a single computer unit, the system can comprise a group/farm of computers which can be scaled depending on the processing load and database size. The computer system 1000 can serve as a common multi-tasking computer.

The computing device 1000 preferably supports an operating system, for example, stored in program storage memory 1090 and executed by the processor 1010 from volatile memory.

Although the invention has been described with respect to specific illustrative embodiments, further modifications and alternatives will be apparent from the description to those of ordinary skill in the art, and the scope of invention is therefore to be determined by the claims that follow.

I claim:

1. A process for providing a seismic image for identifying the location with high resolution of a subsurface microseismic hydro-frac event initiated by fluid movement in a predetermined region of reservoir rock, the process comprising:
a. collecting seismic data for the reservoir;
b. obtaining an estimate of local velocity in the reservoir;
c. calculating the natural Green's function(s) for the earth from the seismic data of step (a) using the formula:
G(x+dx|x′)
where x′ is source location of the seismic data of step (a);
d. extrapolating the phase shift migration from data taken along the surface using a migration operator e^{-iωτ}, where ω is frequency and τ is time, as an extrapolation operator to extrapolate the traces to greater depths;
e. collecting seismic data corresponding to one or more microseismic events occurring in the predetermined region of the reservoir;
f applying the Green's function(s) obtained in step (c) to estimate the location of the microseismic events associated with the data of step (e) in accordance with the following formula:
m(x+dx)=G(x+dx|x′)*d(x′)dx′
where d(x′) represents passive seismic data in the frequency domain along the surface x′, and m(x′) represents the image of the point scatterer, which is equivalent to zero-offset migration of post stack data, and x+dx represents the unknown location of the hydro-frac source and the integration is over the trace locations on the surface; and
g. displaying the results of solving the formula of step (f) as images corresponding to the location of the one or more microseismic events.

2. The process of claim 1, wherein the collected seismic data is surface seismic data.

3. The process of claim 1, wherein the collected seismic data is seismic-while-drilling (SWD) data.

4. The process of claim 1, wherein the collected seismic data is vertical seismic profile (VSP) data.

5. The process of claim 1, wherein the collected seismic data is reverse vertical seismic profile (RVSP) data.

6. A system for providing a seismic image for identifying the location with high resolution of a subsurface microseismic hydro-frac event initiated by fluid movement in a predetermined region of reservoir rock, the system comprising:
a memory that stores calculation modules and data;
a processor coupled to the memory;
a correlating module that receives seismic data from the reservoir;
an estimating module that estimates local velocity in the reservoir;
a first Green's function module that calculates the natural Green's function(s) for the earth from the received seismic data using the formula:
G(x+dx|x′)
where x′ is the source location of the received seismic data;
an extrapolation module that extrapolates the phase shift migration from data taken along the surface using a migration operator e^{-iωτ}, where ω is frequency and τ is time, as an extrapolation operator to extrapolate the traces to greater depths; and
a second Green's function module that receives seismic data corresponding to one or more microseismic events occurring in the predetermined region of the reservoir and applies the Green's function(s) obtained in the first Green's function module to estimate the location of the microseismic events in accordance with the following formula:
m(x+dx)=G(x+dx|x′)*d(x′)dx′
where d(x′) represents passive seismic data in the frequency domain along the surface x′, and m(x′) represents the image of the point scatterer, which is equivalent to zero-offset migration of post stack data, and x+dx represents the unknown location of the hydro-frac source and the integration is over the trace locations on the surface.

7. The process of claim 6, wherein the received seismic data is surface seismic data.

8. The process of claim 6, wherein the received seismic data is seismic-while-drilling (SWD) data.

9. The process of claim 6, wherein the received seismic data is vertical seismic profile (VSP) data.

10. The process of claim 6, wherein the received seismic data is reverse vertical seismic profile (RVSP) data.
